(19) United States
(12) Patent Application Publication
(10) Pub. No.: US 2007/0194908 A1
(43) Pub. Date: Aug. 23, 2007

(54) Radio controlled clock and fire alarm safety

(76) Inventor: Alejandro Ayala, San Bernardino, CA (US)

Correspondence Address: Charles R. Sutton;SIEVERS LAW FIRM, Ste. 302, 201 S. Lake Ave., Pasadena, CA, 91101, US

(21) Appl. No.: 11/586,162

(22) Filed: Oct. 24, 2006

Related U.S. Application Data
(60) Provisional application No. 60/774,472, filed on Feb. 17, 2006.

(51) Int. Cl. G08B 19/00

(52) U.S. Cl. 340/521

(57) ABSTRACT

A radio controlled clock together with a fire alarm, a carbon monoxide gas meter, a thermometer, a pollen meter, and a smog level detector. It can even come equipped with a battery life meter so it is self monitoring. The device is capable of keeping records of the parameters it reads and notifying a remote unit (such as by calling a cellular telephone or sending an electronic mail notification that a parameter has reached a certain level. The radio controlling takes the form of the time and date being automatically adjusted by an atomic clock through radio waves when the batteries are installed. Particulate size and flourescence are used to determine the respective concentrations of airborne particulates using a sensor array.

### CROSS REFERENCE TO RELATED APPLICATION

This application incorporates provisional application No. 60/774,472 by this reference. Provisional application No. 60/774,472 was filed on Feb. 17, 2006. Applicant claims the benefit of the Feb. 17, 2006 filing date pursuant to 35 U.S.C. § 119.

### STATE REGARDING FEDERALLY SPONSORED RESEARCH OR DEVELOPMENT

This invention was not made under Federally-sponsored Research and Development. Applicant retains all rights.

### BACKGROUND OF THE INVENTION

1. Field of the Invention

This invention falls within the field of alarms. The subfields are alarms for fire, or harmful particulates or chemicals in the atmosphere, or time.

2. Description of the Related Art

Alarm clocks have been known for some time which will produce an auditory signal when a certain time is reached. Fire alarms are known that detect smoke in the atmosphere and fire alarms are known that detect heat by means of a bimetallic strip which is deformed by heat until it completes a circuit thus setting off the alarm.

### BRIEF SUMMARY OF THE INVENTION

This radio controlled clock and fire alarm Safety can help to save lives in government buildings, hospitals, schools and even people's homes. When the batteries go out on it, the time goes out also, so the user can know when the device needs new batteries. It is a radio controlled clock together with a fire alarm, a carbon monoxide gas meter, a thermometer, a pollen meter, and a smog level detector. It can even come equipped with a battery life meter so it is self monitoring. The device is capable of keeping records of the parameters it reads and notifying a remote unit (such as by calling a cellular telephone or sending an electronic mail notification that a parameter has reached a certain level. The radio controlling takes the form of the time and date being automatically adjusted by an atomic clock through radio waves when the batteries are installed. This is something everybody needs in their homes.

### BRIEF DESCRIPTION OF THE SEVERAL VIEWS OF THE DRAWINGS

FIG. 1 is a perspective view of the outside of the invention showing its inputs, readouts, and speaker.

FIG. 2 is a detail view of the readouts shown in FIG. 1.

FIG. 3 is a rear view of the device showing the battery access hatch.

### DETAILED DESCRIPTION OF THE INVENTION

This radio controlled clock and fire alarm Safety can help to save lives in government buildings, hospitals, schools and even people's homes. When the batteries go out on it, the time goes out also, so the user can know when the device needs new batteries. It is a radio controlled clock together with a fire alarm, a carbon monoxide gas meter, a thermometer, a pollen meter, and a smog level detector. It can even come equipped with a battery life meter so it is self monitoring. The device is capable of keeping records of the parameters it reads and notifying a remote unit (such as by calling a cellular telephone or sending an electronic mail notification that a parameter has reached a certain level. The radio controlling takes the form of the time and date being automatically adjusted by an atomic clock through radio waves when the batteries are installed. This is something everybody needs in their homes.

About 90% of wood smoke particles are smaller than one micron, as are viruses (0.2 microns) and photochemical smog particles. Weaponized bio-warfare agents are in the size range of 1-5 microns and allergens such as pollen and mold are in the size range of 5-50 microns. Thus, a detector array based on the Mie scattering principle can be used to sort out particles by size. Particles of similar size, such as wood smoke and photochemical smog can be further distinguished by use of heat on the air sample and a tunable dye laser to measure flourescence. In this way, the detector array can sort out the major particulate threats within the sample of room air and assess their concentrations. By adding a memory, the device can use its onboard clock to keep detailed records of the fluctuation of airborne particles of all sizes over the course of time. It can be set to alarm when the pre-established critical limit of any particle type is reached. By the addition of a transmitter or land line output, it can be programmed to signal a remote unit when a pre-established critical particle limit is reached.

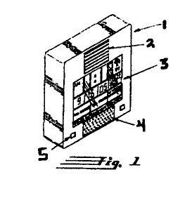

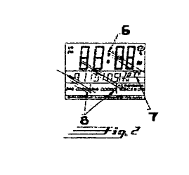

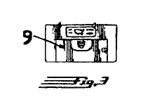

Turning now to FIG. 1, the invention can be seen to have a housing (1) which is optimally plastic. It also has a sensor vent (2), a display (3), an alarm speaker (4), and a flashing alarm light (5). Turning now to FIG. 2 a detailed view of the display (3) is shown. On there can be found an LED clock display (6), a day/temperature display (7), and an air quality display (8). Optimally the display might also include an indicator of battery fullness or remaining lifespan. At FIG. 3 is shown the battery hatch (9) for insertion of batteries as a potential energy source. The device may come as a unit that can be plugged into the AC system of a house.

I claim:

1. In combination:
a power source;
a controller receiving power from said power source and having a memory, a clock, a calendar, a receiver to controller input, a sensor array to controller input, a controller to display output, a controller to transmitter output, and a controller to alarm output;
a sensor array receiving power from said power source and having a thermometer, a particle detector, a heating means, a tunable dye laser, a flourescence detector, and a sensor array to controller output, said sensor array to controller output communicating information gathered by said sensor array to said controller;
a display means receiving power from said power source and having a controller to display input, said display being adapted to indicate the time according to said clock, the date according to said calendar, the temperature according to said thermometer, the concentrations of atmospheric particulates according to said particle detector, and the concentrations of atmospheric pollutants according to said flourescence detector as said time, date, temperature, concentrations of atmospheric particulates, and concentrations of atmospheric pollutants are communicated to said display input by said controller through said controller to display output;
a transmitter receiving power from said power source and having a controller to transmitter input, said transmitter adapted to transmit to a remote device data received at said controller to transmitter input from said controller through said controller to transmitter output;
a receiver powered by said power source having a receiver to controller output, said receiver to controller output adapted to send messages from said receiver to said controller through said receiver to controller input; and
an alarm powered by said power source and having a controller to alarm input, said controller to alarm input adapted to receive signals from said controller through said controller to alarm output and said alarm adapted to provide a cue to a user in response to said signals.

2. The combination of claim 1 wherein the clock is regulated by atomic means.

3. The combination of claim 1 wherein said alarm has a speaker and said cue is an auditory cue.

4. The combination of claim 1 wherein said alarm has a light and a flasher circuit and said cue consists of said light being flashed by said flasher circuit.

5. The combination of claim 1 wherein said heating means heats an atmospheric sample, presents said atmospheric sample to said tunable dye laser so that said flourescence detector can determine concentrations of atmospheric compounds, and wherein said information is said concentrations of atmospheric compounds.

6. The combination of claim 1 wherein said particle detectors detect mie scattering and said information is the number of particles per unit volume in a specified size range.

7. The combination of claim 1 wherein said particle detectors detect rayleigh scattering and said information is the number of particles per unit volume in a specified size range.

8. The combination of claim 1 wherein said data are transmitted wirelessly.

9. The combination of claim I wherein said data are transmitted through the internet.

10. The combination of claim 1 further comprising:
an atomic means which regulates said clock;
a speaker attached to said alarm and said cue is an auditory cue;
said heating means heats an atmospheric sample, presents said atmospheric sample to said tunable dye laser so that said flourescence detector can determine concentrations of atmospheric compounds, and wherein said information is said concentrations of atmospheric compounds;
said particle detectors detect mie scattering and said information is the number of particles per unit volume in a specified size range; and
said data are transmitted wirelessly.

11. The combination of claim 1 further comprising:
an atomic means which regulates said clock;
a speaker attached to said alarm and said cue is an auditory cue;
said heating means heats an atmospheric sample, presents said atmospheric sample to said tunable dye laser so that said flourescence detector can determine concentrations of atmospheric compounds, and wherein said information is said concentrations of atmospheric compounds;
said particle detectors detect mie scattering and said information is the number of particles per unit volume in a specified size range; and
said data are transmitted through the internet.

12. The combination of claim 1 further comprising:
an atomic means which regulates said clock;
said alarm has a light and a flasher circuit and said cue consists of said light being flashed by said flasher circuit;
said heating means heats an atmospheric sample, presents said atmospheric sample to said tunable dye laser so that said flourescence detector can determine concentrations of atmospheric compounds, and wherein said information is said concentrations of atmospheric compounds;
said particle detectors detect mie scattering and said information is the number of particles per unit volume in a specified size range; and
said data are transmitted wirelessly.

13. The combination of claim 1 further comprising:
an atomic means which regulates said clock;
said alarm has a light and a flasher circuit and said cue consists of said light being flashed by said flasher circuit;
said heating means heats an atmospheric sample, presents said atmospheric sample to said tunable dye laser so that said flourescence detector can determine concentrations of atmospheric compounds, and wherein said information is said concentrations of atmospheric compounds;
said particle detectors detect mie scattering and said information is the number of particles per unit volume in a specified size range; and
said data are transmitted through the internet.

14. The combination of claim 1 further comprising:
an atomic means which regulates said clock;
a speaker attached to said alarm and said cue is an auditory cue;
said heating means heats an atmospheric sample, presents said atmospheric sample to said tunable dye laser so that said flourescence detector can determine concentrations of atmospheric compounds, and wherein said information is said concentrations of atmospheric compounds;
said particle detectors detect rayleigh scattering and said information is the number of particles per unit volume in a specified size range; and
said data are transmitted by a means selected from the group comprising wirelessly and the internet.

15. The combination of claim 1 further comprising:
an atomic means which regulates said clock;
a speaker attached to said alarm;
said alarm has a light and a flasher circuit and said cue is selected from the group comprising and auditory cue and said light being flashed by said flasher circuit;
said heating means heats an atmospheric sample, presents said atmospheric sample to said tunable dye laser so that said flourescence detector can determine concentrations of atmospheric compounds, and wherein said information is said concentrations of atmospheric compounds;
said particle detectors detect mie scattering and said information is the number of particles per unit volume in a specified size range; and
said data are transmitted wirelessly.

16. The combination of claim 1 further comprising:
an atomic means which regulates said clock;
a speaker attached to said alarm;
said alarm has a light and a flasher circuit and said cue is selected from the group comprising and auditory cue and said light being flashed by said flasher circuit;
said heating means heats an atmospheric sample, presents said atmospheric sample to said tunable dye laser so that said flourescence detector can determine concentrations of atmospheric compounds, and wherein said information is said concentrations of atmospheric compounds;
said particle detectors detect mie scattering and said information is the number of particles per unit volume in a specified size range; and
said data are transmitted by a means selected from the group comprising wirelessly and the internet.

17. The combination of claim 1 further comprising:
an atomic means which regulates said clock;
a speaker attached to said alarm;
said alarm has a light and a flasher circuit and said cue is selected from the group comprising and auditory cue and said light being flashed by said flasher circuit;
said heating means heats an atmospheric sample, presents said atmospheric sample to said tunable dye laser so that said flourescence detector can determine concentrations of atmospheric compounds, and wherein said information is said concentrations of atmospheric compounds;
said particle detectors detect rayleigh scattering and said information is the number of particles per unit volume in a specified size range; and
said data are transmitted by a means selected from the group comprising wirelessly and the internet.
